(19) United States
(12) Patent Application Publication
(10) Pub. No.: US 2025/0158820 A1
(43) Pub. Date: May 15, 2025

(54) SYSTEMS AND METHODS FOR MANAGING RESOURCE ACCESS PERMISSIONS

(71) Applicant: Capital One Services, LLC, McLean, VA (US)

(72) Inventors: Lawrence DOUGLAS, McLean, VA (US); Jeffrey RULE, Chevy Chase, MD (US); Jackson MACOMBER, Henrico, VA (US)

(73) Assignee: Capital One Services, LLC, McLean, VA (US)

(21) Appl. No.: 18/506,754

(22) Filed: Nov. 10, 2023

(51) Int. Cl. H04L 9/32; G06F 21/60; G06F 21/62

(52) U.S. Cl. CPC H04L 9/3213; G06F 21/602; G06F 21/62

(57) ABSTRACT

Systems and methods for managing resource access permissions for users with secured and unsecured authentication tokens. In some aspects, the system may receive, from a user, a resource access request for a system. The resource access request may include a user identifier and a first activity for the resource access request. The system may retrieve information regarding authentication tokens associated with the user usable to process the resource access request. In response to determining whether the user is associated with the secured authentication token and the unsecured authentication token, the system may process, using a machine learning model, the resource access request to determine a measure of risk to the system that is associated with executing the resource access request for the user. In response to determining that the measure of risk is below a threshold, the system may process the resource access request using the unsecured authentication token.

### SUMMARY

Cloud computing has become an integral part of modern technology infrastructure, allowing users to access and utilize computing resources, applications, and data remotely. It has gained immense popularity due to its scalability, cost-effectiveness, and flexibility. However, the security and integrity of cloud resources have become critical concerns due to potential risks associated with unauthorized access. Therefore, the security of systems, such as computer networks, greatly benefits from strong user authentication and access control protocols. A computer system, such as a data storage system or a high-performance computing (HPC) system, may exclude malicious entities from unauthorized access to system resources. By doing so, a system may protect itself from abuse of resources or other security breaches.

Methods and systems are described herein for novel uses and/or improvements to managing resource access permissions for user requests. As one example, methods and systems are described herein for managing resource access permissions to secured and unsecured resources on a computer system.

While a secured computer system may employ robust access control measures for different types of system resources, an unsecured computer system may only have an initial entry access requirement without need for further access control measures for different types of system resources. With secured computer systems, the emphasis may be on protecting against potential risks and unauthorized access from unknown or lesser-known users. While with unsecured computer systems, known or vetted users may freely access and interact with the system without access control measures for different types of system resources. This setup can be more convenient and user-friendly, but it carries a higher risk of unauthorized access or potential misuse by unknown or lesser-known users.

Existing systems allow users to access either secured or unsecured computer systems. For example, existing systems may allow the user to access a secured or unsecured computer system depending on the status of the user. However, if the user cannot be verified for access to the unsecured computer system, their access may be limited only to the secured computer system.

Methods and systems disclosed herein process, using a machine learning model, the resource access request to determine a measure of risk, and in response to determining that the measure of risk is below a threshold, process the resource access request for the first activity using access to secured resources (e.g., a secured token) or unsecured resources (e.g., a unsecured token) on a computer system. For example, the system may, based on determining the user poses low risk for a proposed activity, allow access to the unsecured resources. Accordingly, the methods and systems provide an efficient way for users to maximize their access to unsecured resources based on the users' current status while still utilizing their secured resources on the computer system.

In some aspects, the system may receive, from a user, a resource access request for a system. The resource access request includes a user identifier and a first activity for the resource access request. The system may retrieve information regarding authentication tokens associated with the user usable to process the resource access request. In response to determining the user is associated with the secured authentication token and the unsecured authentication token, the system may process, using a machine learning model, the resource access request to determine a measure of risk to the system that is associated with executing the resource access request for the first activity for the user. in response to determining that the measure of risk is below a threshold, the system may process the resource access request for the first activity using the unsecured authentication token.

The system may receive a resource access request. In particular, the system may receive, from a user, a resource access request for a system. The resource access request comprises a user identifier and a first activity for the resource access request. For example, a user may request access to a connection to engage with a social media platform.

The system may retrieve information regarding authentication tokens. In particular, the system may retrieve information regarding authentication tokens associated with the user usable to process the resource access request. For example, the system may retrieve the connections the user has access to according to the user account.

The system may determine that the user is associated with a secured authentication token and an unsecured authentication token. In particular, the system may determine that the user is associated with a secured authentication token and an unsecured authentication token. The unsecured authentication token is associated with higher priority resources compared to the secured authentication token. The unsecured authentication token requires a measure of risk associated with the resource access request to be below a threshold risk to avoid abuse of the higher priority resources. For example, the system may select between secured and unsecured resources on a computer system. By doing so, the system is able to determine which type of resources to provide to the user.

The system may determine a measure of risk. In particular, in response to determining the user is associated with the secured authentication token and the unsecured authentication token, the system may process, using a machine learning model, the resource access request to determine a measure of risk to the system that is associated with executing the resource access request for the first activity for the user. For example, the system may check the user's previous history of usage of resources to engage with the social media platform to determine whether to allow access to unsecured resources or limit user access to secured resources on the computer system. By doing so, the system is able to provide an efficient way for users to maximize their access to unsecured resources based on the users' current status while still utilizing their secured resources on the computer system.

The system may process the resource access request. In particular, in response to determining that the measure of risk is below a threshold, the system may process the resource access request for the first activity using the unsecured authentication token. For example, the system may determine the user utilizes a low amount of resources to access the social media platform. Therefore, the system establishes access to unsecured resources on the computer system (e.g., unsecured authentication token).

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for managing resource access permissions for users with secured and unsecured authentication tokens, in accordance with one or more embodiments.

FIGS. 2A-2B shows an illustrative diagram for processing, using a machine learning model, the resource access request to determine a measure of risk, in accordance with one or more embodiments.

FIG. 3 shows illustrative components for a system used to manage resource access permissions, in accordance with one or more embodiments.

FIG. 4 shows a flowchart of the steps involved in managing resource access permissions for users with secured and unsecured authentication tokens, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

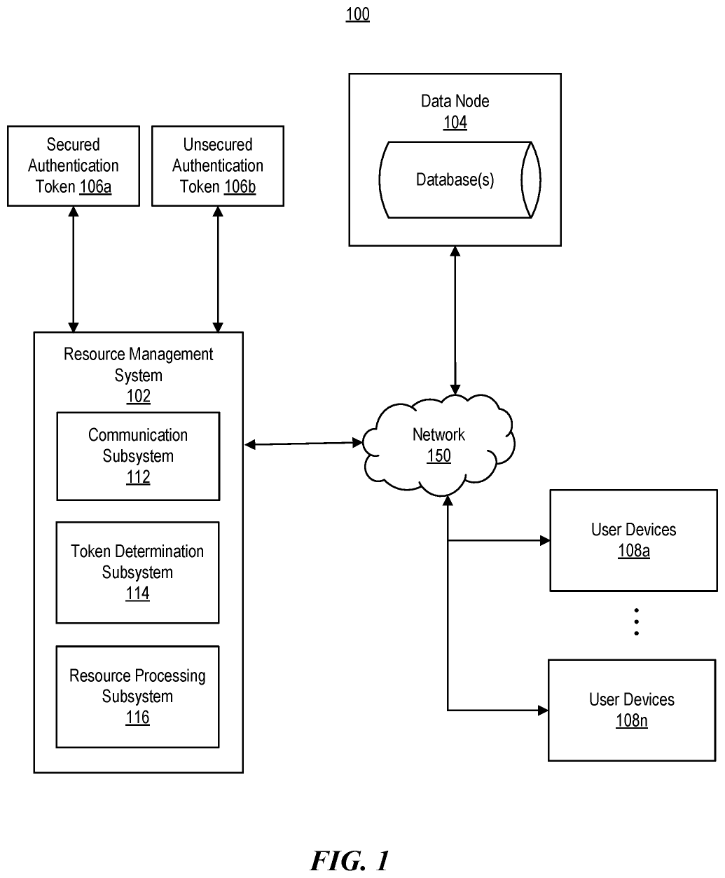

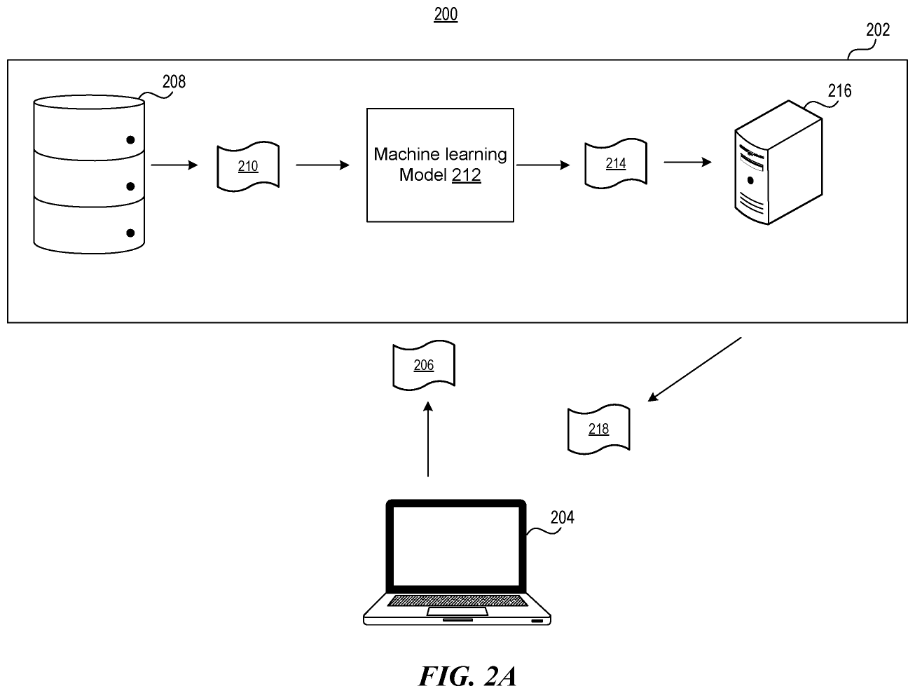

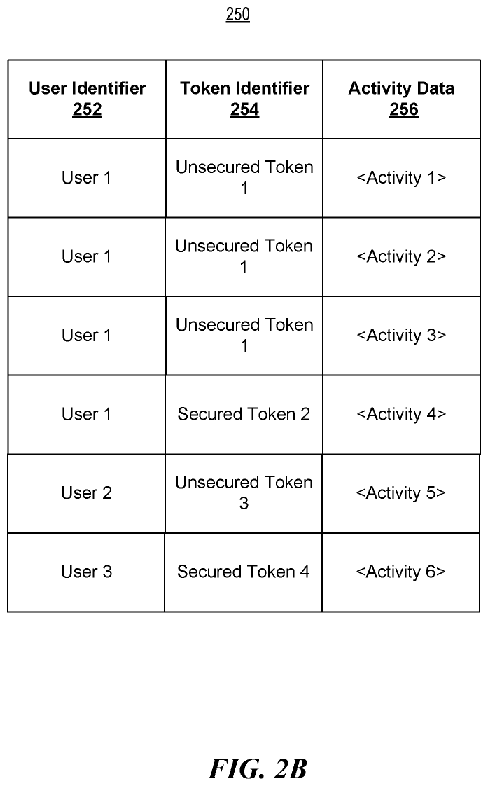

FIG. 1 shows an illustrative diagram for managing resource access permissions for users with secured and unsecured authentication tokens, in accordance with one or more embodiments. Environment 100 includes resource management system 102, data node 104, secured authentication token 106a, unsecured authentication token 106b, and user devices 108a-108n. Resource management system 102 may include software, hardware, or a combination of both and may reside on a physical server or a virtual server running on a physical computer system (e.g., server 202 described with respect to FIG. 2A). In some embodiments, resource management system 102 may be configured on a user device (e.g., a laptop computer, a smartphone, a desktop computer, an electronic tablet, or another suitable user device). Furthermore, resource management system 102 may reside on a cloud-based system and/or interface with computer models either directly or indirectly, for example, through network 150. Resource management system 102 may include communication subsystem 112, token determination subsystem 114, and/or resource processing subsystem 116.

Data node 104 may store various data, including one or more machine learning models, training data, user data profiles, input data, output data, performance data, and/or other suitable data. Data node 104 may include software, hardware, or a combination of the two. In some embodiments, resource management system 102 and data node 104 may reside on the same hardware and/or the same virtual server or computing device. Network 150 may be a local area network, a wide area network (e.g., the Internet), or a combination of the two.

User devices 108a-108n may include software, hardware, or a combination of the two. For example, each client device may include software executed on the device or may include hardware such as a physical device. User devices may include user devices (e.g., a laptop computer, a smartphone, a desktop computer, an electronic tablet, or another suitable user device).

Resource management system 102 may receive resource access requests from one or more user devices. Resource management system 102 may receive data using communication subsystem 112, which may include software components, hardware components, or a combination of both. For example, communication subsystem 112 may include a network card (e.g., a wireless network card and/or a wired network card) that is associated with software to drive the card and enables communication with network 150. In some embodiments, communication subsystem 112 may also receive data from and/or communicate with data node 104 or another computing device. Communication subsystem 112 may receive data, such as activity data or user data. Communication subsystem 112 may communicate with token determination subsystem 114 and resource processing subsystem 116.

Resource management system 102 may include token determination subsystem 114. Communication subsystem 112 may pass at least a portion of the data or a pointer to the data in memory to token determination subsystem 114. Token determination subsystem 114 may include software components, hardware components, or a combination of both. For example, token determination subsystem 114 may include software components or may include one or more hardware components (e.g., processors) that are able to execute operations for processing resource access requests. In some embodiments, a resource access request may refer to a request from user device to a server in resource management system 102 to determine whether to utilize secured authentication token 106a or unsecured authentication token 106b. Token determination subsystem 114 may access data, such as information stored on the secured authentication token 106a or unsecured authentication token 106b. Token determination subsystem 114 may directly access data or nodes associated with user devices 108a-108n and may transmit data to these user devices. Token determination subsystem 114 may, additionally or alternatively, receive data from and/or send data to communication subsystem 112 and resource processing subsystem 116.

Resource processing subsystem 116 may execute tasks relating to processing resource access requests. Resource processing subsystem 116 may include software components, hardware components, or a combination of both. Resource processing subsystem 116 may receive input data, as well as data output by user devices 108a-108n. Resource processing subsystem 116 may, additionally or alternatively, receive data from and/or send data to communication subsystem 112 or token determination subsystem 114.

Resource management system 102 may access secured authentication token 106a and unsecured authentication token 106b to process resource access requests. Secured authentication token 106a and unsecured authentication token 106b may include software components, hardware components, or a combination of both. Secured authentication token 106a and unsecured authentication token 106b may allow resource management system 102 access to an entity.

FIGS. 2A-2B shows an illustrative diagram for processing, using a machine learning model, the resource access request to determine a measure of risk, in accordance with one or more embodiments. FIG. 2A shows environment 200. Environment 200 includes server 202, user device 204, resource access request 206, database 208, token 210, machine learning model 212, metric 214, and processor 216. FIG. 2B shows an exemplary table 250. Table 250 includes user identifier 252, token identifier 254, and activity data 256.

Server 202 may receive a resource access request. In particular, server 202 may receive, from a user, a resource access request (e.g., resource access request 206) for a system. The resource access request may include a user identifier (e.g., user identifier 252) and a first activity for the resource access request (e.g., resource access request 206). For example, the system may receive a purchase request from a user.

Server 202 may retrieve information regarding authentication tokens. In particular, server 202 may retrieve information regarding authentication tokens (e.g., token 210) associated with the user usable to process the resource access request (e.g., resource access request 206). For example, the system may retrieve information about the credit lines that are available to complete the purchase. For example, the system may retrieve information such as the available credit on each line.

Server 202 may determine that the user is associated with a secured authentication token and an unsecured authentication token. In particular, server 202 may determine that the user is associated with a secured authentication token and an unsecured authentication token. The unsecured authentication token is associated with higher priority resources compared to the secured authentication token. The unsecured authentication token requires a measure of risk (e.g., metric 214) associated with the resource access request (e.g., resource access request 206) to be below a threshold risk to avoid abuse of the higher priority resources. For example, the system may select between a secured credit line and an unsecured credit line to process the purchase with. By doing so, the system is able to determine which type of resources to provide to the user.

Server 202 may determine a measure of risk. In particular, in response to determining the user is associated with the secured authentication token and the unsecured authentication token, the system may process, using a machine learning model (e.g., machine learning model 212), the resource access request (e.g., resource access request 206) to determine a measure of risk (e.g., metric 214) to the system that is associated with executing the resource access request (e.g., resource access request 206) for the first activity for the user. In some embodiments, server 202 may receive a resource access history. In particular, when processing, using a machine learning model (e.g., machine learning model 212), the resource access request (e.g., resource access request 206) to determine a measure of risk (e.g., metric 214), server 202 may receive, from a database (e.g., database 208), a resource access history corresponding to the first user. Based on processing the resource access history using the machine learning model (e.g., machine learning model 212), server 202 may determine the measure of risk (e.g., metric 214) associated with executing the resource access request (e.g., resource access request 206) for the first activity for the first user. For example, the system may check the user's previous purchase history and which credit line the user utilized for each purchase to determine whether to use the secured credit line or the unsecured credit line for the current purchase. By doing so, the system is able to provide an efficient way for users to maximize their access to unsecured resources (e.g., unsecured credit line) based on the users' current status while utilizing their secured resources (e.g., secured credit line) where the measure of risk is high (e.g., above a threshold).

In some embodiments, server 202 may determine an amount associated with the resource access request. In particular, when processing, using a machine learning model (e.g., machine learning model 212), the resource access request (e.g., resource access request 206) to determine a measure of risk, server 202 may determine an amount associated with the first activity for the resource access request (e.g., resource access request 206). Server 202 may transmit a request to a database (e.g., database 208) for a plurality of resource access records for the amount associated with the first activity for the resource access request (e.g., resource access request 206). Server 202 may process the plurality of resource access records using the machine learning model (e.g., machine learning model 212) to determine the measure of risk (e.g., metric 214) associated with executing the resource access request for the first activity for the first user. For example, the system may search for previous purchases for the same amount as the current purchase to determine which credit line to utilize. By doing so, the system may determine whether there is a significant risk associated with the purchase.

In some embodiments, server 202 may determine a provider for the resource access request. In particular, when processing, using the machine learning model (e.g., machine learning model 212), the resource access request (e.g., resource access request 206) to determine a measure of risk, server 202 may receive, from a database (e.g., database 208), a resource access history corresponding to the first user. The resource access history may include a plurality of resource access records corresponding to the first user. Server 202 may identify a provider associated with the first activity for the resource access request (e.g., resource access request 206). Server 202 may search each resource access record in the plurality of resource access records for resources access records associated with the provider. Server 202 may determine, using the machine learning model (e.g., machine learning model 212), the measure of risk associated with executing the resource access request for the first activity for the first user based on the provider. For example, the system may search for all transactions with the selected retailer to determine which credit line to use. For instance, if the user repeatedly purchases from this retailer, the current purchase is likely to be paid by the user.

In some embodiments, server 202 may determine the available amount of resources. In particular, when processing, using the machine learning model (e.g., machine learning model 212), the resource access request (e.g., resource access request 206) to determine the measure of risk (e.g., metric 214) to the system that is associated with executing the resource access request (e.g., resource access request 206) for the first activity for the first user, server 202 may transmit a request to determine an available amount of resources corresponding to the first user. In response to determining the available amount of resources corresponding to the first user is less than an amount associated with the first activity, server 202 may determine the measure of risk is higher than the threshold. In another embodiment, when processing, using the machine learning model (e.g., machine learning model 212), the resource access request (e.g., resource access request 206) to determine the measure of risk to the system that is associated with executing the resource access request for the first activity for the first user, server 202 may determine the available amount of resources corresponding to the first user is more than an amount associated with the first activity, determining the measure of risk is lower than the threshold. For example, the purchase amount may be for 200 dollars. The system may check that each credit line has 200 dollars worth of credit available. By doing so, the system is able to ensure that the purchase can be completed.

Server 202 may process the resource access request. In particular, in response to determining that the measure of risk (e.g., metric 214) is below a threshold, server 202 may process the resource access request (e.g., resource access request 206) for the first activity using the unsecured authentication token (e.g., token 210). For example, the system may process the purchase using the unsecured credit line. Therefore, the system establishes access to unsecured resources (e.g., unsecured authentication token).

In some embodiments, server 202 may receive a second resource access request. In particular, server 202 may receive from a second user, a second resource access request (e.g., resource access request 206) for the system. The second resource access request (e.g., resource access request 206) may include a second user identifier (e.g., user identifier 252) and a second activity for the second resource access request (e.g., resource access request 206). Server 202 may retrieve information regarding authentication tokens associated with the second user usable to process the second resource access request (e.g., resource access request 206). Server 202 may determine that the second user is only associated with a second secured authentication token (e.g., token 210). A risk associated with activities executed with the second secured authentication token (e.g., token 210) is accommodated by the second user. Server 202 may process the second resource access request (e.g., resource access request 206) for the second activity using the second secured authentication token (e.g., token 210). For example, the system may check that there is one credit line available for a second user and utilize that line for the purchase.

In some embodiments, server 202 may update the measure of risk. In particular, server 202 may receive, from the first user, a second resource access request (e.g., resource access request 206) for a system. The second resource access request may include the user identifier (e.g., user identifier 252) and a second activity for the second resource access request (e.g., resource access request 206). The system may determine an updated measure of risk to the system that is associated with executing the second resource access request (e.g., resource access request 206) for the first user. In response to determining that the measure of risk is not below the threshold, the system may process the second resource access request (e.g., resource access request 206) for the second activity using the secured authentication token (e.g., token 210). For example, the system may determine an amount limit corresponding to the secured authentication token (e.g., token 210) associated with the first user. The system may update the amount limit after processing the resource access request (e.g., resource access request 206) for the first activity using the secured authentication token (e.g., token 210). By doing so, the system can dynamically determine which authentication token based on the measure of risk.

In some embodiments, server 202 may receive a pre-access request. Server 202 may receive from a user device associated with the first user (e.g., user device 204), a pre-access request. The pre-access request may include a user identifier (e.g., user identifier 252) and an activity for the pre-access request. Server 202 may process, using a machine learning model (e.g., machine learning model 212), the pre-access request to determine a measure of risk (e.g., metric 214) to the system that is associated with executing a resource access request (e.g., resource access request 206) for the activity for the first user. Server 202 may generate a notification to the user device (e.g., user device 204). The notification comprises whether the system processes the resource access request with the unsecured authentication token or the secured authentication token (e.g., token 210) for the activity. By doing so, the system is able to inform the user of which authentication token to use prior to completing a user activity.

In some embodiments, server 202 may identify a periodic activity. In particular, server 202 may identify the first activity as a periodic activity. The periodic activity occurs within a certain timeframe. In response to identifying the first activity as a periodic activity, server 202 may update the measure of risk associated with executing the resource access request for the first activity for the first user. By doing so, the system may recognize a set of activities as safe and therefore, the system may utilize the unsecured authentication token.

In some embodiments, when a user is making a purchase, the system can receive the resource access request (e.g., purchase request). After receiving the resource access request (e.g., the purchase and the associated purchase details) such as a user identifier and activity details, the system can retrieve information regarding the types of credit lines (e.g., authentication tokens) the user can utilize for completing the purchase. In response to determining that the user has both a secured credit line and an unsecured credit line, the system determines a measure of risk associated with the purchase using machine learning model 212. For instance, the system can analyze the user's previous purchase history to determine whether the user can pay back the purchase they are currently making. For example, if the user always pays back their purchases, the system can determine there is a lower measure of risk of allowing the user to complete this purchase with the unsecured credit line. After determining which credit line (e.g., token) to utilize, the system can automatically update the available credit on the chosen credit line after finalizing the purchase.

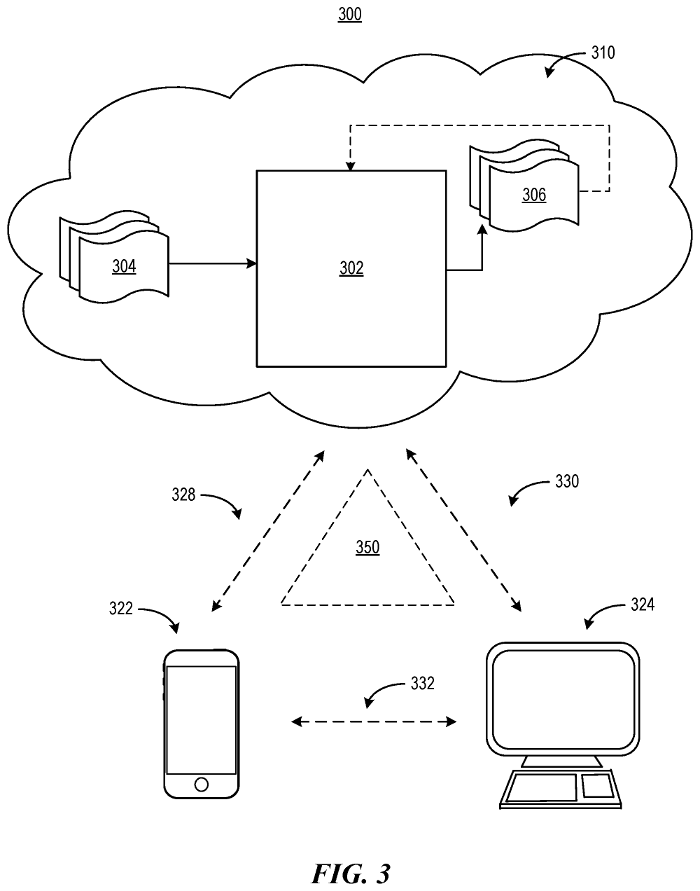

FIG. 3 shows illustrative components for a system used to manage resource access permissions, in accordance with one or more embodiments. For example, FIG. 3 may show illustrative components for processing resource access requests for users with access to bother secured and unsecured authentication tokens. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include resource management system 102, communication subsystem 112, token determination subsystem 114, resource processing subsystem 116, secured authentication token 106a, unsecured authentication token 106b, data node 104, or user devices 108a-108n. Cloud components 310 may access secured authentication token 106a and unsecured authentication token 106b and user devices 108a-108n.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., detecting a measure of risk associated with executing the resource access request).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., whether the activity is associated with a secured authentication token or a unsecured authentication token).

In some embodiments, the model (e.g., model 302) may automatically perform actions based on outputs 306. In some embodiments, the model (e.g., model 302) may not perform any actions. The output of the model (e.g., model 302) may be used to determine a measure of risk that is associated with executing the resource access request for the first activity for the user.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

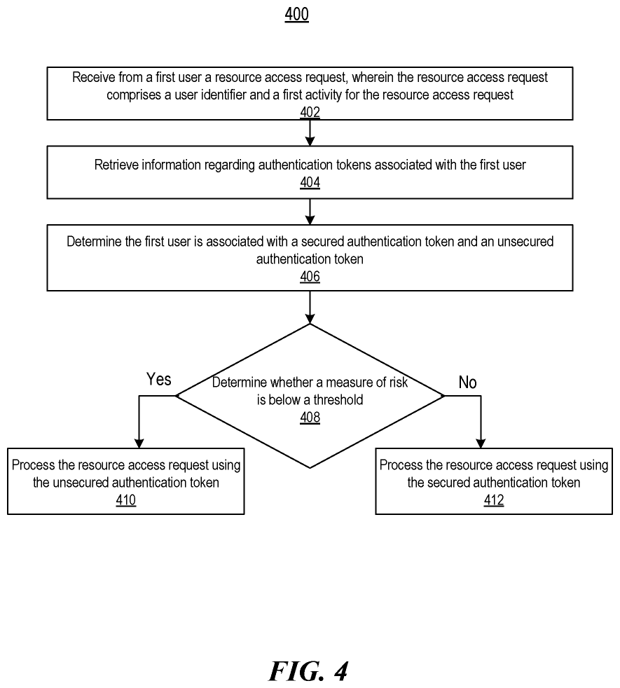

FIG. 4 shows a flowchart of the steps involved in managing resource access permissions for users with secured and unsecured authentication tokens, in accordance with one or more embodiments. For example, the system may use process 400 (e.g., as implemented on one or more system components described above) in order to efficiently distribute resources.

At operation 402, process 400 (e.g., using one or more components described above) may receive a resource access request. In particular, communication subsystem 112 which may reside on cloud components 310 may receive, from a user, a resource access request (e.g., resource access request 206) for a system. The resource access request may include a user identifier (e.g., user identifier 252) and a first activity for the resource access request (e.g., resource access request 206). For example, the system may receive a purchase request from a user using communication paths 328, 330, and 332.

At operation 404, process 400 (e.g., using one or more components described above) may retrieve information regarding authentication tokens. In particular, token determination subsystem 114 which may reside on cloud components 310 may retrieve information regarding authentication tokens (e.g., token 210) associated with the user usable to process the resource access request (e.g., resource access request 206). For example, the system may retrieve information about the credit lines that are available to complete the purchase. For example, the system may retrieve information such as the available credit on each line using communication paths 328, 330, and 332.

At operation 406, process 400 (e.g., using one or more components described above) may determine that the user is associated with a secured authentication token and an unsecured authentication token. In particular, token determination subsystem 114 may determine that the user is associated with a secured authentication token and an unsecured authentication token. The unsecured authentication token is associated with higher priority resources compared to the secured authentication token. The unsecured authentication token requires a measure of risk (e.g., metric 214) associated with the resource access request (e.g., resource access request 206) to be below a threshold risk to avoid abuse of the higher priority resources. For example, the system may select between a secured credit line and an unsecured credit line to process the purchase with. By doing so, the system is able to determine which type of resources to provide to the user.

At operation 408, process 400 (e.g., using one or more components described above) may determine a measure of risk. In particular, in response to determining the user is associated with the secured authentication token and the unsecured authentication token, the system may process, using a machine learning model (e.g., machine learning model 212), the resource access request (e.g., resource access request 206) to determine a measure of risk (e.g., metric 214) to the system that is associated with executing the resource access request (e.g., resource access request 206) for the first activity for the user. In some embodiments, the system may receive a resource access history. In particular, when processing, using a machine learning model (e.g., machine learning model 212), the resource access request (e.g., resource access request 206) to determine a measure of risk (e.g., metric 214), communication subsystem 112 may receive, from a database (e.g., database 208), a resource access history corresponding to the first user. Based on processing the resource access history using the machine learning model (e.g., machine learning model 212), server 202 may determine the measure of risk (e.g., metric 214) associated with executing the resource access request (e.g., resource access request 206) for the first activity for the first user. For example, the system may check the user's previous purchase history and which credit line the user utilized for each purchase to determine whether to use the secured credit line or the unsecured credit line for the current purchase. By doing so, the system is able to provide an efficient way for users to maximize their access to unsecured resources (e.g., unsecured credit line) based on the users' current status while still utilizing their secured resources (e.g., secured credit line).

In some embodiments, the system may determine an amount associated with the resource access request. In particular, when processing, using a machine learning model (e.g., machine learning model 212), the resource access request (e.g., resource access request 206) to determine a measure of risk, the system may determine an amount associated with the first activity for the resource access request (e.g., resource access request 206). The system may transmit a request to a database (e.g., database 208) for a plurality of resource access records for the amount associated with the first activity for the resource access request (e.g., resource access request 206). The system may process the plurality of resource access records using the machine learning model (e.g., machine learning model 212 or model 302) to determine the measure of risk (e.g., metric 214) associated with executing the resource access request for the first activity for the first user. For example, the system may search for previous purchases for the same amount as the current purchase to determine which credit line to utilize via communication subsystem 112. By doing so, the system may determine whether there is a significant risk associated with the purchase.

In some embodiments, the system may determine a provider for the resource access request. In particular, when processing, using the machine learning model (e.g., machine learning model 212), the resource access request (e.g., resource access request 206) to determine a measure of risk, the system may receive, from a database (e.g., database 208), a resource access history corresponding to the first user. The resource access history may include a plurality of resource access records corresponding to the first user. The system may identify a provider associated with the first activity for the resource access request (e.g., resource access request 206 or input 304). The system may search each resource access record in the plurality of resource access records for resources access records associated with the provider. The system may determine, using the machine learning model (e.g., machine learning model 212 or model 302), the measure of risk (e.g., metric 214 or output 306) associated with executing the resource access request for the first activity for the first user based on the provider. For example, the system may search for all transactions with the selected retailer to determine which credit line to use using communication subsystem 112. For instance, if the user repeatedly purchases from this retailer, the current purchase is likely to be paid by the user.

In some embodiments, the system may determine the available amount of resources. In particular, when processing, using the machine learning model (e.g., machine learning model 212 or model 302), the resource access request (e.g., resource access request 206 or input 304) to determine the measure of risk (e.g., metric 214 or output 306) to the system that is associated with executing the resource access request (e.g., resource access request 206) for the first activity for the first user, the system may transmit a request to determine an available amount of resources corresponding to the first user. In response to determining the available amount of resources corresponding to the first user is less than an amount associated with the first activity, the system may determine the measure of risk is higher than the threshold. In another embodiment, when processing, using the machine learning model (e.g., machine learning model 212 or model 302), the resource access request (e.g., resource access request 206) to determine the measure of risk to the system that is associated with executing the resource access request for the first activity for the first user, the system may determine the available amount of resources corresponding to the first user is more than an amount associated with the first activity, determining the measure of risk is lower than the threshold via resource processing subsystem 116. For example, the purchase amount may be for 200 dollars. The system may check that each credit line has 200 dollars worth of credit available. By doing so, the system is able to ensure that the purchase can be completed.

At operation 410, process 400 (e.g., using one or more components described above) may process the resource access request using the unsecured authentication token. In particular, in response to determining that the measure of risk (e.g., metric 214) is below a threshold, the system may process the resource access request (e.g., resource access request 206) for the first activity using the unsecured authentication token (e.g., token 210). For example, the system may process the purchase using the unsecured credit line.

At operation 412, process 400 (e.g., using one or more components described above) may process the resource access request using the secured authentication token. In particular, in response to determining that the measure of risk is not below a threshold, the system may process the resource access request for the first activity using the secured authentication token. For example, the system may process the purchase using the secured credit line.

In some embodiments, the system may receive a second resource access request. In particular, the system may receive from a second user, a second resource access request (e.g., resource access request 206) for the system. The second resource access request (e.g., resource access request 206) may include a second user identifier (e.g., user identifier 252) and a second activity for the second resource access request (e.g., resource access request 206). Server 202 may retrieve information regarding authentication tokens associated with the second user usable to process the second resource access request (e.g., resource access request 206). Server 202 may determine that the second user is only associated with a second secured authentication token (e.g., token 210). A risk associated with activities executed with the second secured authentication token (e.g., token 210) is accommodated by the second user. Server 202 may process the second resource access request (e.g., resource access request 206) for the second activity using the second secured authentication token (e.g., token 210) via resource processing subsystem 116. For example, the system may check that there is one credit line available for a second user and utilize that line for the purchase.

In some embodiments, the system may update the measure of risk. In particular, the system may receive, from the first user, a second resource access request (e.g., resource access request 206) for a system via communication subsystem 112. The second resource access request may include the user identifier (e.g., user identifier 252) and a second activity for the second resource access request (e.g., resource access request 206). The system may determine an updated measure of risk to the system that is associated with executing the second resource access request (e.g., resource access request 206) for the first user. In response to determining that the measure of risk is not below the threshold, the system may process the second resource access request (e.g., resource access request 206) for the second activity using the secured authentication token (e.g., token 210) using resource processing subsystem 116. For example, the system may determine an amount limit corresponding to the secured authentication token (e.g., token 210) associated with the first user. The system may update the amount limit after processing the resource access request (e.g., resource access request 206) for the first activity using the secured authentication token (e.g., token 210).

In some embodiments, the system may receive a pre-access request. The system may receive from a user device associated with the first user (e.g., user device 204), a pre-access request. The pre-access request may include a user identifier (e.g., user identifier 252) and an activity for the pre-access request. The system may process, using a machine learning model (e.g., machine learning model 212 or model 302), the pre-access request to determine a measure of risk (e.g., metric 214) to the system that is associated with executing a resource access request (e.g., resource access request 206) for the activity for the first user. The system may generate a notification to the user device (e.g., user device 204). The notification comprises whether the system processes the resource access request with the unsecured authentication token or the secured authentication token (e.g., token 210) for the activity.

In some embodiments, the system may identify a periodic activity. In particular, the system may identify the first activity as a periodic activity. The periodic activity occurs within a certain timeframe. In response to identifying the first activity as a periodic activity, the system may update the measure of risk (e.g., metric 214) associated with executing the resource access request for the first activity for the first user using resource processing subsystem 116.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising receiving, from a user, a resource access request for a system, wherein the resource access request comprises a user identifier and a first activity for the resource access request; retrieving information regarding authentication tokens associated with the user usable to process the resource access request; determining that the user is associated with a secured authentication token and an unsecured authentication token, wherein the unsecured authentication token is associated with higher priority resources compared to the secured authentication token, wherein the unsecured authentication token requires a measure of risk associated with the resource access request to be below a threshold risk to avoid abuse of the higher priority resources; in response to determining the user is associated with the secured authentication token and the unsecured authentication token, processing, using a machine learning model, the resource access request to determine a measure of risk to the system that is associated with executing the resource access request for the first activity for the user; and in response to determining that the measure of risk is below a threshold, processing the resource access request for the first activity using the unsecured authentication token.
2. A method comprising: receiving, from a first user, a resource access request for a system, wherein the resource access request comprises a user identifier and a first activity for the resource access request; retrieving information regarding authentication tokens associated with the first user usable to process the resource access request, the authentication tokens including a secured authentication token and an unsecured authentication token associated with the first user, wherein the unsecured authentication token is associated with higher priority resources compared to the secured authentication token, wherein the unsecured authentication token requires a measure of risk associated with the resource access request to be below a threshold risk to avoid abuse of the higher priority resources; processing, using a machine learning model, the resource access request to determine a measure of risk to the system that is associated with executing the resource access request for the first activity for the first user; and in response to determining that the measure of risk is below a threshold, processing the resource access request for the first activity using the unsecured authentication token.
3. A method comprising: receiving, from a first user, a resource access request for a system, wherein the resource access request comprises a user identifier and a first activity for the resource access request; retrieving information regarding authentication tokens associated with the first user usable to process the resource access request, the authentication tokens including a secured authentication token and an unsecured authentication token associated with the first user, wherein the unsecured authentication token is associated with higher priority resources compared to the secured authentication token, wherein the unsecured authentication token requires a measure of risk associated with the resource access request to be below a threshold risk to avoid abuse of the higher priority resources; determining that the first user is associated with a secured authentication token and an unsecured authentication token, wherein the unsecured authentication token is associated with higher priority resources compared to the secured authentication token, wherein the unsecured authentication token requires a measure of risk associated with the resource access request to be below a threshold risk to avoid abuse of the higher priority resources; in response to determining the first user is associated with the secured authentication token and the unsecured authentication token, processing, using a machine learning model, the resource access request to determine a measure of risk to the system that is associated with executing the resource access request for the first activity for the first user; and in response to determining that the measure of risk is not below a threshold, processing the resource access request for the first activity using the secured authentication token.
4. The method of any one of the preceding embodiments, further comprising: receiving, from a second user, a second resource access request for the system, wherein the second resource access request comprises a second user identifier and a second activity for the second resource access request; retrieving information regarding authentication tokens associated with the second user usable to process the second resource access request; determining that the second user is only associated with a second secured authentication token, wherein a risk associated with activities executed with the second secured authentication token is accommodated by the second user; and processing the second resource access request for the second activity using the second secured authentication token.
5. The method of any one of the preceding embodiments, wherein processing, using a machine learning model, the resource access request to determine a measure of risk further comprises: receiving, from a database, a resource access history corresponding to the first user; and based on processing the resource access history using the machine learning model, determining the measure of risk associated with executing the resource access request for the first activity for the first user.
6. The method of any one of the preceding embodiments, wherein processing, using a machine learning model, the resource access request to determine a measure of risk further comprises: determining an amount associated with the first activity for the resource access request; transmitting a request to a database for a plurality of resource access records for the amount associated with the first activity for the resource access request; and processing the plurality of resource access records using the machine learning model to determine the measure of risk associated with executing the resource access request for the first activity for the first user.
7. The method of any one of the preceding embodiments, further comprising: receiving, from the first user, a second resource access request for a system, wherein the second resource access request comprises the user identifier and a second activity for the second resource access request; determining an updated measure of risk to the system that is associated with executing the second resource access request for the first user; and in response to determining that the measure of risk is not below the threshold, processing the second resource access request for the second activity using the secured authentication token.
8. The method of any one of the preceding embodiments, further comprising: determining an amount limit corresponding to the secured authentication token associated with the first user; and updating the amount limit after processing the resource access request for the first activity using the secured authentication token.
9. The method of any one of the preceding embodiments, wherein processing, using the machine learning model, the resource access request to determine the measure of risk to the system that is associated with executing the resource access request for the first activity for the first user further comprises: transmitting a request to determine an available amount of resources corresponding to the first user; and in response to determining the available amount of resources corresponding to the first user is more than an amount associated with the first activity, determining the measure of risk is lower than the threshold.
10. The method of any one of the preceding embodiments, wherein processing, using the machine learning model, the resource access request to determine the measure of risk to the system that is associated with executing the resource access request for the first activity for the first user further comprises: transmitting a request to determine an available amount of resources corresponding to the first user; and in response to determining the available amount of resources corresponding to the first user is less than an amount associated with the first activity, determining the measure of risk is higher than the threshold.
11. The method of any one of the preceding embodiments, further comprising: receiving, from a user device associated with the first user, a pre-access request, wherein the pre-access request comprises a user identifier and an activity for the pre-access request; processing, using a machine learning model, the pre-access request to determine a measure of risk to the system that is associated with executing a resource access request for the activity for the first user; and generating a notification to the user device, wherein the notification comprises whether the system processes the resource access request with the unsecured authentication token or the secured authentication token for the activity.
12. The method of any one of the preceding embodiments, wherein processing, using the machine learning model, the resource access request to determine a measure of risk further comprises: receiving, from a database, a resource access history corresponding to the first user, wherein the resource access history comprises a plurality of resource access records corresponding to the first user; identifying a provider associated with the first activity for the resource access request; searching each resource access record in the plurality of resource access records for resources access records associated with the provider; and determining, using the machine learning model, the measure of risk associated with executing the resource access request for the first activity for the first user based on the provider.
13. The method of any one of the preceding embodiments, further comprising: identifying the first activity as a periodic activity, wherein the periodic activity occurs within a certain timeframe; and in response to identifying the first activity as a periodic activity, updating the measure of risk associated with executing the resource access request for the first activity for the first user.
14. A tangible, non-transitory, computer-readable medium storing instructions that, when executed by a data processing apparatus, cause the data processing apparatus to perform operations comprising those of any of embodiments 1-13.
15. A system comprising one or more processors; and memory storing instructions that, when executed by the processors, cause the processors to effectuate operations comprising those of any of embodiments 1-13.
16. A system comprising means for performing any of embodiments 1-13.
17. A system comprising cloud-based circuitry for performing any of embodiments 1-13.

What is claimed is:

1. A system for managing resource access permissions for users with secured and unsecured authentication tokens, comprising:
one or more processors; and
one or more non-transitory computer-readable media storing instructions that when executed by the one or more processors cause operations comprising:
receiving, from a user, a resource access request for a system, wherein the resource access request comprises a user identifier and a first activity for the resource access request;
retrieving information regarding authentication tokens associated with the user usable to process the resource access request;
determining that the user is associated with a secured authentication token and an unsecured authentication token, wherein the unsecured authentication token is associated with higher priority resources compared to the secured authentication token, wherein the unsecured authentication token requires a measure of risk associated with the resource access request to be below a threshold risk to avoid abuse of the higher priority resources;
in response to determining the user is associated with the secured authentication token and the unsecured authentication token, processing, using a machine learning model, the resource access request to determine a measure of risk to the system that is associated with executing the resource access request for the first activity for the user; and
in response to determining that the measure of risk is below a threshold, processing the resource access request for the first activity using the unsecured authentication token.

2. A method for managing resource access permissions for users with secured and unsecured authentication tokens, comprising:
receiving, from a first user, a resource access request for a system, wherein the resource access request comprises a user identifier and a first activity for the resource access request;
retrieving information regarding authentication tokens associated with the first user usable to process the resource access request, the authentication tokens including a secured authentication token and an unsecured authentication token associated with the first user, wherein the unsecured authentication token is associated with higher priority resources compared to the secured authentication token, wherein the unsecured authentication token requires a measure of risk associated with the resource access request to be below a threshold risk to avoid abuse of the higher priority resources;
processing, using a machine learning model, the resource access request to determine a measure of risk to the system that is associated with executing the resource access request for the first activity for the first user; and
in response to determining that the measure of risk is below a threshold, processing the resource access request for the first activity using the unsecured authentication token.

3. The method of claim 2, further comprising:
receiving, from a second user, a second resource access request for the system, wherein the second resource access request comprises a second user identifier and a second activity for the second resource access request;
retrieving information regarding authentication tokens associated with the second user usable to process the second resource access request;
determining that the second user is only associated with a second secured authentication token, wherein a risk associated with activities executed with the second secured authentication token is accommodated by the second user; and
processing the second resource access request for the second activity using the second secured authentication token.

4. The method of claim 2, wherein processing, using a machine learning model, the resource access request to determine a measure of risk further comprises:
receiving, from a database, a resource access history corresponding to the first user; and
based on processing the resource access history using the machine learning model, determining the measure of risk associated with executing the resource access request for the first activity for the first user.

5. The method of claim 2, wherein processing, using a machine learning model, the resource access request to determine a measure of risk further comprises:
determining an amount associated with the first activity for the resource access request;
transmitting a request to a database for a plurality of resource access records for the amount associated with the first activity for the resource access request; and
processing the plurality of resource access records using the machine learning model to determine the measure of risk associated with executing the resource access request for the first activity for the first user.

6. The method of claim 2, further comprising:
receiving, from the first user, a second resource access request for a system, wherein the second resource access request comprises the user identifier and a second activity for the second resource access request;
determining an updated measure of risk to the system that is associated with executing the second resource access request for the first user; and
in response to determining that the measure of risk is not below the threshold, processing the second resource access request for the second activity using the secured authentication token.

7. The method of claim 6, further comprising:
determining an amount limit corresponding to the secured authentication token associated with the first user; and
updating the amount limit after processing the resource access request for the first activity using the secured authentication token.

8. The method of claim 2, wherein processing, using the machine learning model, the resource access request to determine the measure of risk to the system that is associated with executing the resource access request for the first activity for the first user further comprises:
transmitting a request to determine an available amount of resources corresponding to the first user; and
in response to determining the available amount of resources corresponding to the first user is less than an amount associated with the first activity, determining the measure of risk is higher than the threshold.

9. The method of claim 2, wherein processing, using the machine learning model, the resource access request to determine the measure of risk to the system that is associated with executing the resource access request for the first activity for the first user further comprises:
transmitting a request to determine an available amount of resources corresponding to the first user; and
in response to determining the available amount of resources corresponding to the first user is more than an amount associated with the first activity, determining the measure of risk is lower than the threshold.

10. The method of claim 2, further comprising:
receiving, from a user device associated with the first user, a pre-access request, wherein the pre-access request comprises a user identifier and an activity for the pre-access request;
processing, using a machine learning model, the pre-access request to determine a measure of risk to the system that is associated with executing a resource access request for the activity for the first user; and
generating a notification to the user device, wherein the notification comprises whether the system processes the resource access request with the unsecured authentication token or the secured authentication token for the activity.

11. The method of claim 2, wherein processing, using the machine learning model, the resource access request to determine a measure of risk further comprises:
receiving, from a database, a resource access history corresponding to the first user, wherein the resource access history comprises a plurality of resource access records corresponding to the first user;
identifying a provider associated with the first activity for the resource access request;
searching each resource access record in the plurality of resource access records for resources access records associated with the provider; and
determining, using the machine learning model, the measure of risk associated with executing the resource access request for the first activity for the first user based on the provider.

12. The method of claim 2, further comprising:
identifying the first activity as a periodic activity, wherein the periodic activity occurs within a certain timeframe; and
in response to identifying the first activity as a periodic activity, updating the measure of risk associated with executing the resource access request for the first activity for the first user.

13. One or more non-transitory, computer-readable storage media storing instructions that, when executed by one or more processors, cause operations comprising:
receiving, from a first user, a resource access request for a system, wherein the resource access request comprises a user identifier and a first activity for the resource access request;
retrieving information regarding authentication tokens associated with the first user usable to process the resource access request, the authentication tokens including a secured authentication token and an unsecured authentication token associated with the first user, wherein the unsecured authentication token is associated with higher priority resources compared to the secured authentication token, wherein the unsecured authentication token requires a measure of risk associated with the resource access request to be below a threshold risk to avoid abuse of the higher priority resources;
determining that the first user is associated with a secured authentication token and an unsecured authentication token, wherein the unsecured authentication token is associated with higher priority resources compared to the secured authentication token, wherein the unsecured authentication token requires a measure of risk associated with the resource access request to be below a threshold risk to avoid abuse of the higher priority resources;
in response to determining the first user is associated with the secured authentication token and the unsecured authentication token, processing, using a machine learning model, the resource access request to determine a measure of risk to the system that is associated with executing the resource access request for the first activity for the first user; and
in response to determining that the measure of risk is not below a threshold, processing the resource access request for the first activity using the secured authentication token.

14. The one or more non-transitory, computer-readable storage media of claim 13, wherein the instructions further cause the one or more processors to perform operations comprising:
receiving, from a second user, a second resource access request for the system, wherein the second resource access request comprises a second user identifier and a second activity for the second resource access request;
retrieving information regarding authentication tokens associated with the second user usable to process the second resource access request;
determining that the second user is only associated with a second secured authentication token, wherein a risk associated with activities executed with the second secured authentication token is accommodated by the second user; and
processing the second resource access request for the second activity using the second secured authentication token.

15. The one or more non-transitory, computer-readable storage media of claim 13, wherein processing, using a machine learning model, the resource access request to determine a measure of risk further comprises:
receiving, from a database, a resource access history corresponding to the first user; and
based on processing the resource access history using the machine learning model, determining the measure of risk associated with executing the resource access request for the first activity for the first user.

16. The one or more non-transitory, computer-readable storage media of claim 13, wherein processing, using a machine learning model, the resource access request to determine a measure of risk further comprises:
determining an amount associated with the first activity for the resource access request;
transmitting a request to a database for a plurality of resource access records for the amount associated with the first activity for the resource access request; and
processing the plurality of resource access records using the machine learning model to determine the measure of risk associated with executing the resource access request for the first activity for the first user.

17. The one or more non-transitory, computer-readable storage media of claim 13, wherein the instructions further cause the one or more processors to perform operations comprising:
receiving, from the first user, a second resource access request for a system, wherein the second resource access request comprises the user identifier and a second activity for the second resource access request;
determining an updated measure of risk to the system that is associated with executing the second resource access request for the first user; and
in response to determining that the measure of risk is not below the threshold, processing the second resource access request for the second activity using the secured authentication token.

18. The one or more non-transitory, computer-readable storage media of claim 17, wherein the instructions further cause the one or more processors to perform operations comprising:
determining an amount limit corresponding to the secured authentication token associated with the first user; and
updating the amount limit after processing the resource access request for the first activity using the secured authentication token.

19. The one or more non-transitory, computer-readable storage media of claim 13, wherein the instructions further cause the one or more processors to perform operations comprising:
receiving, from a user device associated with the first user, a pre-access request, wherein the pre-access request comprises a user identifier and an activity for the pre-access request;
processing, using a machine learning model, the pre-access request to determine a measure of risk to the system that is associated with executing a resource access request for the activity for the first user; and
generating a notification to the user device, wherein the notification comprises whether the system processes the resource access request with the unsecured authentication token or the secured authentication token for the activity.

20. The one or more non-transitory, computer-readable storage media of claim 13, wherein the instructions further cause the one or more processors to perform operations comprising:
identifying the first activity as a periodic activity, wherein the periodic activity occurs within a certain timeframe; and
in response to identifying the first activity as a periodic activity, updating the measure of risk associated with executing the resource access request for the first activity for the first user.
